(19) United States
(12) Patent Application Publication
(10) Pub. No.: US 2008/0092535 A1
(43) Pub. Date: Apr. 24, 2008

(54) SYSTEMS AND METHODS USING GRAVITY AND BUOYANCY FOR PRODUCING ENERGY

(75) Inventor: Izrafeel Razack, Las Vegas, NV (US)

Correspondence Address: Doherty IP Law Group LLC, 5 Mountain Ridge Drive, Oxford, NJ, 07863, US

(73) Assignee: Passive Energy Limited

(21) Appl. No.: 11/862,070

(22) Filed: Sep. 26, 2007

Related U.S. Application Data
(60) Provisional application No. 60/848,337, filed on Sep. 28, 2006.

(51) Int. Cl. F03B 17/04

(52) U.S. Cl. 60/496; 74/DIG. 9

(57) ABSTRACT

A system for producing energy includes expandable vessels that are submerged in a liquid. The vessels are collapsible for sinking in the liquid due to gravitational forces and are expandable for rising in the liquid due to buoyancy forces. As the vessels sink in the liquid, the vessels rotate a shaft for generating energy. In one embodiment, the system includes a tank holding a liquid, an air-tight, expandable vessel disposed within the liquid and being adapted to move reciprocally between upper and lower ends of the tank, a conduit attached to the vessel for passing gas into and out of the vessel, and a linkage for selectively coupling the vessel with a rotatable shaft. The vessel is moveable between a collapsed state in which the vessel sinks in the liquid due to gravitational forces and an expanded state in which the vessel rises in the liquid due to buoyancy forces.

### CROSS-REFERENCE TO RELATED APPLICATIONS

The present application claims the benefit of U.S. Provisional Application Ser. No. 60/848,337, filed Sep. 28, 2006, the disclosure of which is hereby incorporated by reference herein.

### BACKGROUND OF THE INVENTION

1. Field of the Invention

Embodiments of the present invention generally relate to systems and methods for producing energy. More specifically, embodiments of the present invention relate to systems and methods that use gravity and buoyancy for producing energy.

2. Description of the Related Art

There are many different systems and techniques used for producing energy. For example, power plants are typically located near rivers and dams. The power plants use the force of flowing water to rotate turbines, which, in turn, produce energy such as electricity. One problem with using water as an energy source, however is that the power plants must be located adjacent the supply of water.

Another type of power plant uses energy that is stored in fossil fuels, such as coal, oil, and gas. In these types of power plants, the fossil fuel is burned to produce heat that rotates shafts or turbines, which, in turn, produce electricity. Other power plants use nuclear fuel rods to generate steam that drives turbines to produce electricity.

In response to diminishing supplies of fossil fuels, and in order to minimize the environmental impact of producing energy, alternative sources of energy are presently being developed including wind power, tides, waves, geothermal sources, solar power and nuclear fusion.

There have also been many advances that use gravity and buoyancy to produce energy. For example, U.S. Pat. No. 5,996,344 to Frenette et al. discloses a buoyancy device including a hollow shaft supporting a plurality of buoyancy legs equally spaced about the periphery of the hollow shaft. One end of each buoyancy leg is connected to the shaft in a water tight manner while the opposite end of each buoyancy leg supports a buoyancy chamber. A piston is located within the buoyancy chamber and is movable from a fully retracted state to a fully extended state by operation of a weight. The buoyancy chamber, when in a retracted state, is filled with water and provides a balanced state for the shaft. The piston, when in a fully extended state, provides a buoyant state to the buoyancy chamber which imparts rotational torque on the shaft. A mechanism is provided for automatically changing the position of the piston, from the fully retracted state to the fully extended state, or, from the fully extended state to the fully retracted state each time the buoyancy leg is located in a substantially vertical orientation.

U.S. Pat. No. 6,546,726 to Tomoiu teaches a gravity power plant for producing electricity utilizing the buoyancy of a liquid. First and second expandable chambers are each placed in a liquid filled shaft. The expandable chambers are coupled together with a cable so that when one of the expandable chambers is raised, the other one is lowered. The cable is coupled to a pulley for turning a generator for producing electricity. An electrode and electrolyte are placed within each expandable chamber for generating heat and steam to expand the expandable chamber when the expandable chamber is at the bottom of the liquid-filled shaft. The increased volume of the expandable chamber causes it to rise in the liquid-filled shaft at the same time as the other expandable chamber is reduced in volume and caused to be lowered in the other liquid-filled shaft. A valve in the expandable chamber may be opened to release steam, thereby enabling the volume of the expandable chamber to be reduced. The released steam may be used to power a turbine or enter a heat exchanger.

U.S. Pat. No. 3,934,964 to Diamond discloses a gravity-activated fluid displacement power generator including a plurality of piston-sealed cylinders that are secured in oppositely spaced relationship to each other about the circumference of a rotational member having substantially horizontal axes of rotation. The rotational members and all of the cylinders are submerged within a fluid medium. Cylinders on the vertically upwardly moving side of the rotational member have their pistons withdrawn from sealed ends of the cylinders to create a large air space, reducing the weight of each cylinder to less than the weight of the quantity of the fluid medium which each cylinder displaces, thereby giving each cylinder buoyancy. Cylinders on the vertically downward side of the rotational member have their pistons inserted substantially into the cylinders close to the sealed ends, reducing the air space, increasing the weight of each cylinder to a total weight greater than the weight of the amount of fluid medium displaced, whereby each cylinder tends to sink vertically downwardly. The unbalanced condition of the cylinders drives the rotational member.

U.S. Patent Application Publication 2005/0235640 to Armstrong teaches a force producing assembly having a plurality of changeable buoyant structures, each having an elastic surface that accommodates changing the buoyancy of the buoyant structure. The assembly includes air lines that aid in volume change of the buoyant structures.

U.S. Pat. No. 5,430,333 to Binford et al. discloses an energy generating system having a plurality of inflation devices that are linked to one another to form a loop that is movably restrained so that a segment of the loop is disposed at a lower reference location at the given depth in a first body of water, another segment of the loop is disposed at an upper reference location situated above the lower reference location, another segment of the loop extends along a first path that extends generally upward from the lower reference location to the upper reference location, and another segment of the loop extends along a second path that extends generally parallel to the first path and upward from the lower reference location to the upper reference location. At least a majority of the inflation devices occupying the first path are inflated with gas and at least a majority of the inflation devices occupying the second path are deflated so that inflation devices in the first path move upward and inflation devices in the second path move downward. The traveling or movement of the inflation devices is utilized to elevate water that flows, under the force of gravity, through a hydroelectric generating facility that generates electricity.

U.S. Pat. No. 4,242,868 to Smith discloses a hydropower generation system for converting potential energy into kinetic energy. A pair of parallel, flexible belts is joined by rigid links or rungs affixed at their ends to each belt and passing over one or more rotatable gears having radial teeth with a pitch equal to the spacing of the links. The belts are turned by mechanisms attached thereto, which are exposed to either the kinetic force of flowing water, or the buoyant force of a body of water upon elements attached directly to the belt.

U.S. Pat. No. 6,803,670 to Peloquin discloses a method and apparatus for generating energy using fluid supported bodies, each disposed in one of a plurality of chambers filled with a fluid. The fluid has a density that is greater than the body so that the bodies are all buoyant in the fluid. A rotatable shaft is supported above the chambers, with each of said bodies being coupled to the shaft through a clutch mechanism for driving the shaft in rotation. The fluid in each of the chambers is selectively evacuated whenever the body in the respective chamber has been lifted to a preselected height within the chamber. The rate of evacuation of the fluid is greater than the rate of descent of the body so that after the fluid has been evacuated from the chamber, the body experiences “controlled” free fall and in so doing it turns the rotatable shaft. The series of bodies falling in the chambers is timed so that at any time, there is at least one body experiencing “controlled” free fall in free space.

U.S. Pat. No. 6,009,707 to Alkhamis teaches a device for generating energy from a source of pressurized fluid by harnessing buoyancy and/or gravitational forces. The apparatus includes at least one container having an inlet port on a top side for receiving the pressurized fluid while the container is at the top of a tank, and a drainage port on a bottom side for draining the pressurized fluid while the container is at the bottom of the tank. A chain belt is attached to the container so that the chain belt rotates as the container travels. A shaft is connected to the chain belt for producing rotational energy.

U.S. Patent 2007/0080540 to Tung discloses a hydraulic buoyancy kinetic energy apparatus having two buoys that are located at an upper position and a lower position respectively. A chain is connected between the two buoys so as to alternatively move the two buoys. Water inside a water tank fills an air storage cylinder to push the air into the lower buoy to produce buoyancy to float upward, and the upper buoy gradually fills up with water to produce a gravitational force and to force air into air storage hood. The two buoys are moved alternatively up and down for generating electric power.

In spite of the above advances, there remains a need for more efficient and economic systems and methods for producing energy. There also remains a need for energy producing systems that are non-polluting and inexpensive to operate. In addition, there is a need for energy producing systems that do not require external power to operate.

### SUMMARY OF THE INVENTION

Embodiments of the present invention relate to a system for producing energy that does not require fossil fuel or another external power source. The present invention produces energy that is safe, reliable and non-polluting.

In one embodiment of the present invention, a system for producing energy includes a tank holding a liquid, such as water, an air-tight, expandable vessel disposed within the liquid and being adapted to move reciprocally between upper and lower ends of the tank, a conduit, such as a flexible hose, attached to the expandable vessel for passing gases into and out of the vessel, and a linkage for selectively coupling the vessel with a rotatable shaft. The vessel is desirably moveable between a collapsed state in which the vessel sinks in the liquid due to gravitational forces and an expanded state in which the vessel rises in the liquid due to buoyancy forces. In other words, the vessel is less buoyant than the liquid when collapsed and more buoyant than the liquid when expanded.

In one embodiment, the linkage drives rotation of the shaft when the vessel sinks and the linkage decouples from the shaft when the vessel rises. As a result, the shaft is able to rotate continuously in the same direction as the vessel sinks and rises in the liquid. In one embodiment, the linkage preferably includes a sprocket disposed on the shaft for driving rotation of the shaft when the sprocket rotates in a first direction and freewheeling relative to the shaft when the sprocket rotates in a second direction. The linkage may also include a one-way clutch.

In one preferred embodiment, each of the vessels is capable of producing up to one million ft/lbs of torque on the rotatable shaft. In other embodiments, the amount of torque produce may be even greater. The tanks holding the liquid may be 30 feet or more in height and the vessels may sink 20 feet or more and rise 20 feet or more during each cycle. In some embodiments, the vessels may be placed in open bodies of liquid (e.g. the ocean) for producing energy.

In one embodiment of the present invention, the expandable vessel preferably includes an expandable chamber having an upper chamber section and a lower chamber section that is telescopically receivable within the upper chamber section. The upper chamber section desirably has an internal volume that is larger than an internal volume of the lower chamber section. Although the present invention is not limited by any particular theory of operation, it is believed that providing an upper chamber having a larger volume than the lower chamber received therein, the vessel will produce sufficient buoyancy forces for moving the vessel upwardly after the vessel has been expanded.

In certain preferred embodiments of the present invention, the system may include a flexible diaphragm extending between the upper and lower chamber sections for forming an air-tight seal between the upper and lower chamber sections. The flexible diaphragm may be provided on the outside or the inside of the upper and lower chamber sections. In one embodiment, the diaphragm may be provided on both the outside and the inside of the upper and lower chamber sections. In one embodiment, an air-tight compartment may be formed between the upper and lower chamber sections by using any one of a broad range of flexible sealing materials including rubber, plastic, polymers, flexible sheets, etc. The upper and lower chamber sections are desirably coupled together by sliding brackets that enable the lower chamber section to be telescopically received within the upper chamber section. In one embodiment, the upper and lower chamber sections are coupled together using two sliding brackets. In other preferred embodiments, the upper and lower chamber sections may be coupled together using three, four, or more sliding brackets. The sliding brackets preferably facilitate smooth and reliable sliding motion between the upper and lower chamber sections.

In one embodiment, the system includes a plurality of air-tight, expandable vessels coupled with a rotatable shaft, whereby each expandable vessel desirably moves independently of one another. The system may also include a support frame surrounding the upper and lower chamber sections. In one embodiment, the upper chamber section is connected to the support frame for limiting movement of the upper chamber section relative to the support frame and the lower chamber section is freely moveable relative to the support frame. The system may include rigging coupled with the linkage, the support frame and the lower chamber member for selectively moving the lower chamber section into the upper chamber section.

In one or more embodiments, the vessel may include support legs that are attached to the upper chamber section and that extend below the bottom cover of the lower chamber section when the vessel is fully expanded. The support legs preferably abut against the bottom floor of the tank when the vessel is sinking in the tank. The support legs desirably arrest downward motion of the vessel when the vessel reaches the bottom of the tank. The support legs desirably have sufficient length to enable the lower chamber section to fully extend relative to the upper chamber section. In one embodiment, the vessel may not include the support frame described above, but only have the support legs for supporting the vessel when the vessel sinks to the bottom of the tank, or sinks to the floor of an open body of water. In other embodiments, the vessel may have both the support frame and the support legs attached to the upper chamber section.

In one embodiment of the present invention, a system for producing energy includes at least one tank holding a liquid, a plurality of air-tight, expandable vessels disposed within the liquid, each vessel being adapted to move reciprocally between upper and lower ends of the at least one tank, a conduit attached to each vessel for passing gasses into and out of the vessels, and linkages for coupling the vessels with a rotatable shaft. The vessels are desirably moveable between a collapsed state during which the vessels sink in the liquid due to gravitational forces for rotating the shaft, and an expanded state during which the vessels rise in the liquid due to buoyancy forces.

Each vessel desirably includes an air-tight, expandable chamber having an upper chamber section and a lower chamber section that is telescopically received within the upper chamber section. The linkage may include a one or more one-way clutches that drive the shaft when the vessels are sinking and that freewheel relative to the shaft when the vessels are rising. The vessels may be disposed at different elevations relative to one another so that at any one time at least one of the vessels is collapsed for sinking for driving the shaft and at least one of the vessels is expanded for rising for reaching the top of the liquid to create potential energy that may be coupled to the shaft.

In one embodiment of the present invention, a method of producing energy includes submerging a plurality of air-tight vessels in a liquid, collapsing one or more of the vessels so as to make the collapsed vessels less buoyant than the liquid, expanding one or more of the vessels so as to make the expanded vessels more buoyant than the liquid, coupling the collapsed vessels to a rotatable shaft for rotating the shaft as the collapsed vessels sink in the liquid, and decoupling the expanded vessels from the rotatable shaft as the expanded vessels rise in the liquid. The method may include linking the vessels to the shaft using one way clutches. Conduits may be connected to each vessel for drawing air into the vessels as the vessels are expanded and exhausting air from the vessels as the vessels are collapsed. In operation, the vessels may be positioned at different elevations relative to one another in the liquid. The collapsed vessels preferably drive rotation of the shaft due to gravitational forces and the expanded vessels rise to the top of the liquid due to buoyancy forces.

In one embodiment of the present invention, a system generates constant torque on a shaft, which may be used to turn a turbine or generator or any other device to produce energy such as electricity. The system may include a tank or receptacle of liquid or water, or a body of water having a specified minimum depth above which is placed a shaft in a harness or other device which will allow the shaft to turn freely. The system desirably includes one way sprockets or other gear mechanisms that are attached to the shaft or other device so that they turn the shaft in one direction and freewheel in the opposite direction. Cables, chains, lines or similar devices may be looped over or otherwise attached to the sprockets so that movement of the cables or chains causes the shaft to turn when weighted vessels attached to the cables or chains fall through the liquid.

In one embodiment, expandable vessels made of heavy metal or other durable materials are attached to the cables or chains. The expandable vessels include hinges or flexible couplings at every corner so that the vessels can be collapsed into an almost knifelike shape at the top of the tank or liquid, which enables the vessels to fall through the liquid using gravity as the only force. The amount of force exerted on the shaft will preferably equal the actual weight of the vessels less any reduction caused by the mass/density of the vessels.

In one embodiment, the vessels are preferably attached to guide rails or other mechanisms which control the path that the vessels can travel and the depth to which the vessels can descend. The vessels are designed so that when the lowest end of the vessel reaches the end of the guide rails, the panels of the vessels begin to open along the hinges or flexible couplings, which cause them to expand and change shape so that they are capable of holding air or other gasses. The result is that the vessels open into an expanded state, whereby the vessel becomes buoyant in the liquid and rises to the top of the liquid. The vessels may be covered with a waterproof membrane or coating or otherwise rendered waterproof for allowing air or other gasses to be trapped inside.

In one embodiment, the flexible couplings or hinges of the vessels are ratcheted so that as the vessels settle, the flexible couplings or hinges become locked into position so that the vessels maintain their original, expanded state. Ambient or other air or other gasses may be introduced into the vessels using flexible hoses or other means as the vessels expand. Once the vessels have returned to their expanded state, the vessels preferably begin to rise to the surface of the liquid using the principle of buoyancy as the only force. When the vessels are collapsed, trapped air or other gaseous material is exhausted through the flexible hose or other outlet.

In one embodiment, the system includes sprockets that only turn the shaft when the vessels are sinking in the liquid. When the vessels are rising in the liquid, the sprockets rotate independently of the shaft (i.e. freewheeling). When the tops of the vessels breach the top surface of the liquid and attempt to settle back into the liquid, the mechanical ratcheting locks are preferably released, thereby enabling the vessels to move into the collapsed state. In one embodiment, the vessels collapse along the hinges, assisted by a spring attached to the top and bottom ends of the vessel.

In one embodiment, multiple vessels are positioned on the shaft so that one or more vessels are falling and one or more vessels are rising at all times. Preferably, only the vessels that are falling are driving rotation of the shaft. As a result, the shaft is constantly rotating in the same direction. The shaft may be connected to a gear mechanism or gearbox. The rate of descent of the vessels may be controlled by multiplying the shaft rotation using the gear mechanism or gearbox.

In one embodiment, the output end of the shaft is preferably connected to a turbine or generator or other device such as a hydraulic pump or other type of pump which causes a generator to turn, thus producing electricity. The shaft may also be connected to any device that requires torque. The torque produced by the present invention may be adjusted by using gears attached to the shaft.

These and other preferred embodiments of the present invention will be described in more detail below.

### BRIEF DESCRIPTION OF THE DRAWING

So the manner in which the above recited features of the present invention can be understood in detail, a more particular description of embodiments of the present invention, briefly summarized above, may be had by reference to embodiments, which are illustrated in the appended drawing. It is to be noted, however, the appended drawing illustrates only typical embodiments of embodiments encompassed within the scope of the present invention, and, therefore, is not to be considered limiting, for the present invention may admit to other equally effective embodiments, wherein:

FIG. 1 shows a perspective view of a vessel for an energy system having an expandable and collapsible chamber, in accordance with one preferred embodiment of the present invention.

FIGS. 2A-2C show an upper chamber section of the vessel shown in FIG. 1.

FIGS. 3A-3C show a lower chamber section of the vessel shown in FIG. 1.

FIG. 4 shows the upper chamber section of FIG. 2A having a venting conduit coupled therewith, in accordance with one preferred embodiment of the present invention.

FIG. 5 shows the upper and lower chamber sections coupled together, in accordance with one preferred embodiment of the present invention.

FIGS. 6A-6C show a support frame for the vessel of FIG. 1, in accordance with certain preferred embodiments of the present invention.

FIGS. 7A-7C show a mounting bracket for the vessel of FIG. 1, in accordance with certain preferred embodiments of the present invention.

FIGS. 8A-8C show a stabilizing spring for the vessel of FIG. 1, in accordance with certain preferred embodiments of the present invention.

FIG. 9A shows an isometric view of the vessel shown in FIG. 1.

FIG. 9B shows a front elevational view of the vessel shown in FIG. 9A.

FIG. 9C shows a side elevational view of the vessel shown in FIG. 9B.

FIGS. 10A-10C show an energy system at a first stage of an energy production cycle, in accordance with certain preferred embodiments of the present invention.

FIGS. 11A-11C show an energy system at a second stage of an energy production cycle, in accordance with certain preferred embodiments of the present invention.

FIGS. 12A-12C show an energy system at a third stage of an energy production cycle, in accordance with certain preferred embodiments of the present invention.

FIGS. 13A-13C show an energy system at a fourth stage of an energy production cycle, in accordance with certain preferred embodiments of the present invention.

FIGS. 14A-14C show an energy system at a fifth stage of an energy production cycle, in accordance with certain preferred embodiments of the present invention.

FIGS. 15A-15C show an energy system at a sixth stage of an energy production cycle, in accordance with certain preferred embodiments of the present invention.

FIGS. 16A-16C show an energy system at a seventh stage of an energy production cycle, in accordance with certain preferred embodiments of the present invention.

FIGS. 17A-17C show an energy system at an eighth stage of an energy production cycle, in accordance with certain preferred embodiments of the present invention.

FIGS. 18A-18C show an energy system at a ninth stage of an energy production cycle, in accordance with certain preferred embodiments of the present invention.

FIGS. 19A-19C show an energy system at a tenth stage of an energy production cycle, in accordance with certain preferred embodiments of the present invention.

FIG. 20 shows a cross-sectional view of an energy system, in accordance with certain preferred embodiments of the present invention.

FIG. 21 shows a system for producing energy, in accordance with another preferred embodiment of the present invention.

FIG. 22 shows a perspective view of one of the units of the system shown in FIG. 21.

FIG. 23 shows a vessel for the system of FIG. 21, in accordance with certain preferred embodiments of the present invention.

FIG. 24 shows a sprocket and chain used to couple an energy producing vessel to a shaft, in accordance with certain preferred embodiments of the present invention.

FIG. 25 shows another view of the system shown in FIG. 21.

### DETAILED DESCRIPTION

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

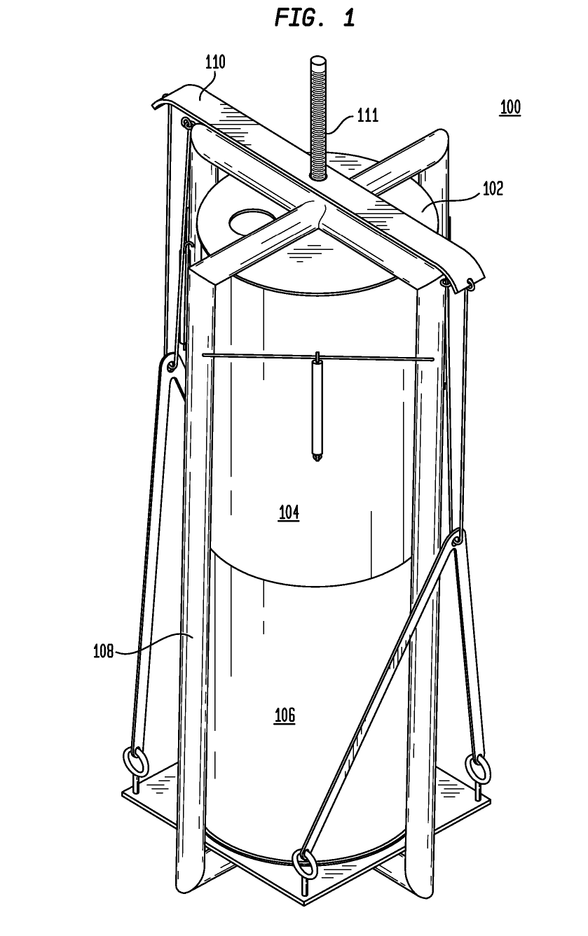

Referring to FIG. 1, in one preferred embodiment of the present invention, an energy system includes a vessel 100 having an expandable and collapsible chamber 102 having an upper chamber section 104 and a lower chamber section 106. The vessel 100 includes a support frame 108 that surrounds the chamber 102 and a mounting bracket 110 overlying an upper end of the support frame 108. The vessel includes a torque-generating line 111 that is attached to the mounting bracket 110 and that has an upper end coupled with a sprocket attached to a rotatable, power-generating shaft (not shown). As will be described in more detail below, when the vessel moves downwardly due to gravitational forces, the line 111 also moves downwardly for rotating the sprocket and the power-generating shaft so as to produce energy. When the vessel moves upwardly due to the forces of buoyancy, the sprocket on the rotatable shaft is adapted to freewheel relative to the power-generating shaft.

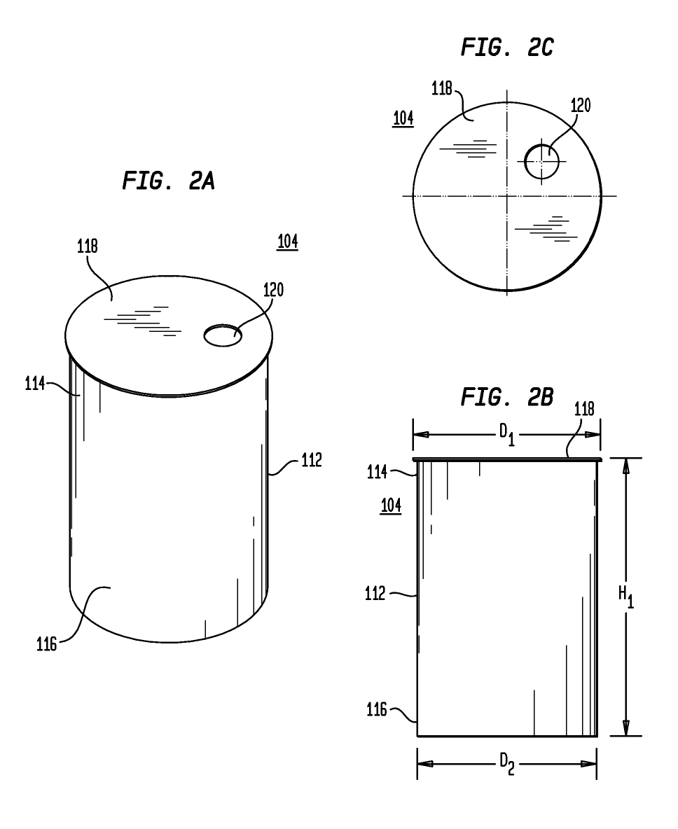

Referring to FIGS. 2A-2C, in one preferred embodiment of the present invention, the upper chamber section 104 has an outer wall 112 with an upper end 114 and a lower end 116. The outer wall 112 surrounds a hollow space that extends between the upper and lower ends 114, 116 thereof. In the embodiment of FIGS. 2A-2C, the outer wall of the upper chamber section has a cylindrical shape; however, the outer wall may have other shapes when viewed in cross-section (e.g., square, parallelogram, triangular, etc.). The upper chamber section 104 includes a top cover 118 that is secured to and overlies the hollow space at the upper end 114 of the outer wall 112. The top cover 118 has a vent opening 120 extending therethrough so that air may flow into and out of the hollow space surrounded by the outer wall 112. Referring to FIG. 2B, in one embodiment of the present invention, the cover has an outer diameter D1 of about 12-12.5 inches, the outer wall has an outer diameter D2 of about 12 inches, and the upper chamber section 104 has a height of about 16 inches. The dimensions of the upper chamber section, as well as any component shown and described herein, may be readily changes in order to maximize the production of energy, improve efficiency, and reduce costs. The dimensions of the components may also change in response to site parameters or client needs and still fall within the scope of the present invention. Thus, although particular dimensions are provided herein, the invention is not limited to the disclosed dimensions.

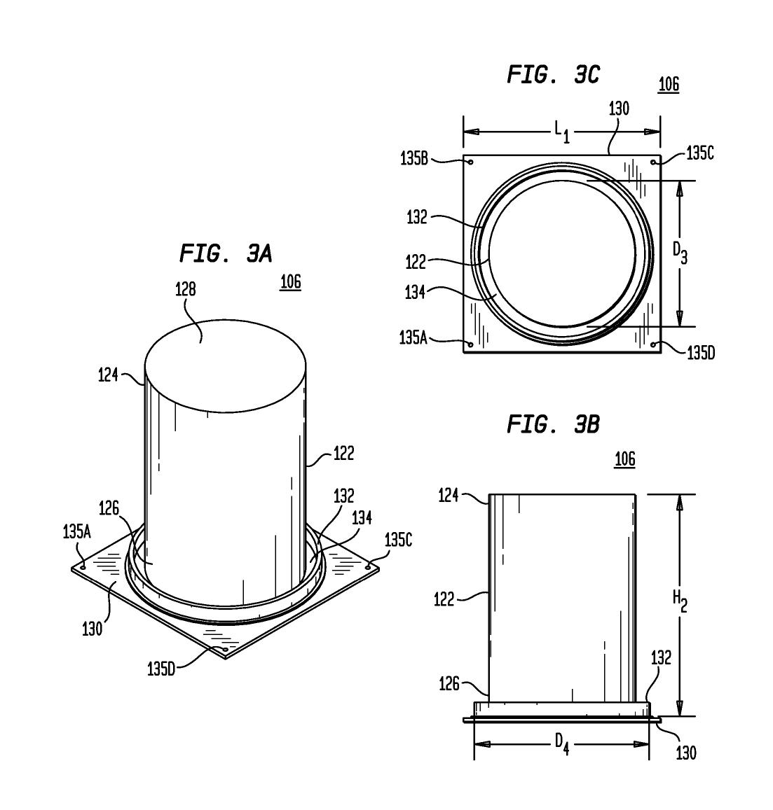

Referring to FIGS. 3A-3C, in one embodiment of the present invention, the lower chamber section 106 has an outer wall 122 having an upper end 124 and a lower end 126. The outer wall 122 surrounds a hollow space 128 that extends between the upper and lower ends 124, 126. The outer wall of the lower chamber section 122 has a cylindrical shape, however, in other preferred embodiments, the outer wall may have other geometric shapes when viewed in cross-section (e.g., square, parallelogram, triangle, etc.). The lower chamber section 106 includes a bottom cover 130 that is secured to the lower end 126 of the outer wall 122, and that underlies the hollow space 128.

The lower chamber section 106 includes a sealing rim 132 that projects upwardly from the upper surface of the bottom cover 130. The sealing rim 132 is preferably spaced from and surrounds the outer wall 122 of the lower chamber section 106. Referring to FIG. 3C, the bottom cover 130 has a square shape having sides having a length L1 of about. In other embodiments, the bottom cover may have other shapes (e.g., circular, rectangular, triangular, parallelogram, etc.). The outer wall 122 has a diameter D3 of about 10 inches, and the sealing rim 132 has a diameter D4 of about 12 inches. The lower chamber section preferably has a height of about 14 inches. In one embodiment, the diameter of the sealing rim and the diameter of the outer wall of the upper chamber section are conformed to one another so that an air-tight seal may be formed between the upper chamber section and the lower chamber section. In one embodiment, the diameter D4 of the sealing rim is preferably greater than the diameter D3 of the outer wall 122 of the lower chamber section 106. Referring to FIGS. 2A and 3A, when the upper chamber section 104 and the lower chamber section 106 are collapsed toward one another, the lower end 116 of the outer wall 112 of the upper chamber section 104 is preferably disposable in a gap 134 that extends between the rim 132 and the outer wall 122.

In one preferred embodiment, the upper chamber section is significantly lighter than the lower chamber section. In one embodiment, the upper chamber section is over ten times lighter than the lower chamber section. In one particular preferred embodiment, the upper chamber section weighs about seven pounds, the support frame weighs about five pounds and the lower chamber section weighs about 120 pounds. The upper chamber section may be made of a wide range of light-weight materials including polymers and plastics. The lower chamber section is desirably made of heavier weight materials such as metals, alloys, cement and concrete. Although the present invention is not limited by any particular theory of operation, it is believed that the wide weight ratio differences between the upper chamber section and the lower chamber section (e.g. 1:10), results in an expandable vessel having a vastly improved buoyancy characteristics. In particular, providing an upper chamber section that has a larger internal volume and lower weight than the lower chamber section, enables the upper chamber section to more efficiently move away from the lower chamber section during the expansion stage of the energy producing cycle.

Referring to FIGS. 3A and 3C, the bottom cover 130 preferably has openings 135A-135D adapted to receive rigging, such as straps or chains. In one embodiment, the rigging may be secured directly to the openings 135A-135D. In another embodiment, however, anchors such as eye-bolts may be secured to the openings 135A-135D and the rigging may be secured to the anchors. As will be described in more detail below, the rigging is preferably secured to the vessel to selectively collapse the vessel. The rigging is desirably flexible so as to move relative to the vessel during collapsing and expanding the vessel.

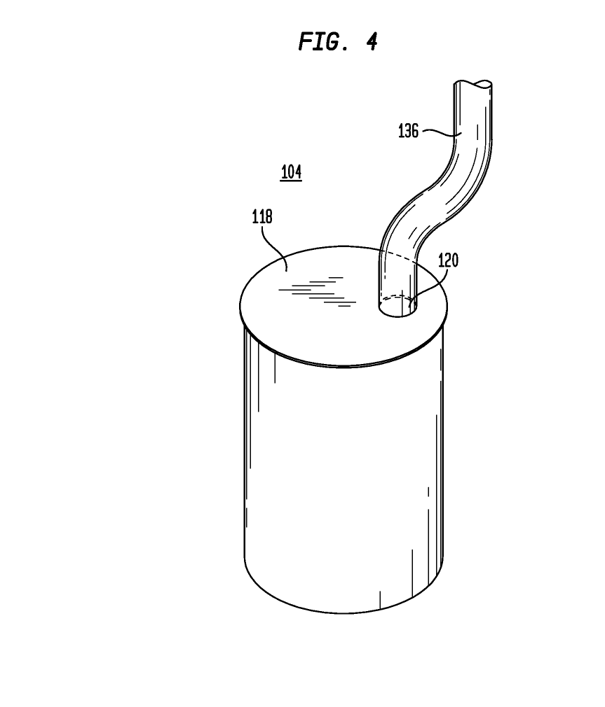

Referring to FIG. 4, in one embodiment of the present invention, at least one of the vessels includes a venting conduit 136 coupled with the vent opening 120 formed in the top cover 118 of the upper chamber section 104. The venting conduit 136 is designed to enable a gaseous fluid, such as ambient air, to readily flow into and out of the hollow space of the chamber as the vessel is expanded and collapsed. When the vessel is expanded, the air is preferably drawn into the hollow space of the chamber through the venting conduit 136. In contrast, when the vessel is collapsed, the venting conduit 136 enables air to be discharged from the venting conduit.

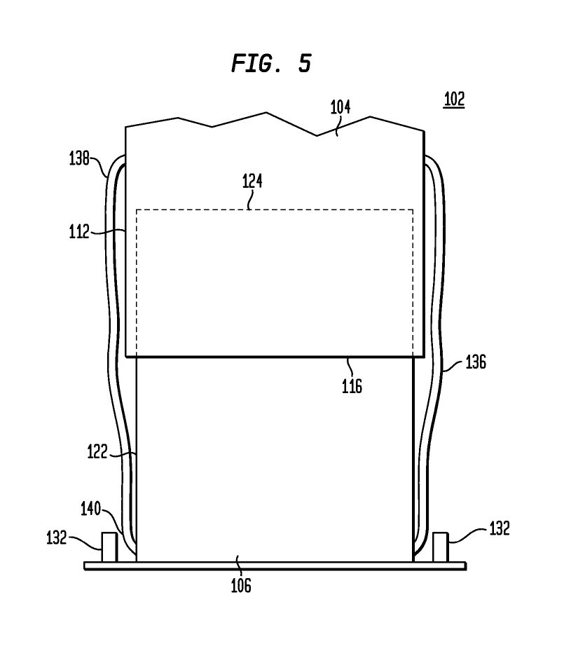

Referring to FIG. 5, in one embodiment of the present invention, the upper chamber section 104 and the lower chamber section 106 are coupled together by sliding the lower end 116 of the upper chamber section 104 over the upper end 124 of the lower chamber section 106. As noted above, the lower end 116 of the upper chamber section has a larger diameter than the upper end 124 of the lower chamber section so that the upper section is slidable over the outer wall 122 of the lower chamber section 106. The expandable and collapsible chamber 102 also includes a diaphragm 136 that has an upper end 138 secured to the outer wall 112 of the upper chamber section 104 and a lower end 140 secured to the outer wall 122 of the lower chamber section 106. The diaphragm 136 preferably forms an airtight and watertight seal between the upper and lower chamber sections 104, 106. The diaphragm 136 is desirably flexible for maintaining the airtight and watertight seal as the chamber 102 is expanded and collapsed, as will be described in more detail below.

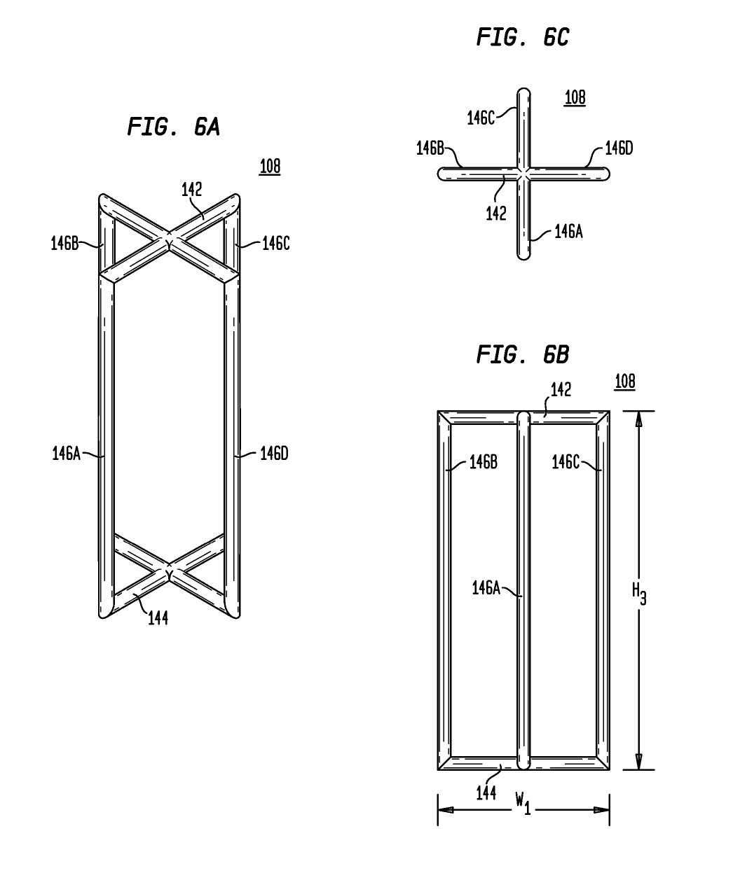

Referring to FIGS. 6A-6C, in one embodiment of the present invention, the support frame 108 for the vessel 102 (FIG. 1) has an upper cruciform-shaped support 142, a lower cruciform-shaped support 144, and support bars 146A-146D that extend between the upper support 142 and the lower support 144. In one embodiment, the support bars 146A-146D are parallel to one another and extend substantially vertically between the upper support 142 and the lower support 144. The expandable and collapsible chamber 102 (FIG. 5) is preferably disposed inside the support frame 108. In one embodiment, the upper chamber section 104 is coupled to the support frame 108. The upper chamber section may be rigidly secured to the support frame so that it cannot move relative to the support frame. In other embodiments, the upper chamber section is coupled to the support frame but is adapted to move relative to the support frame. In these embodiments, the upper chamber section can be coupled to the support frame using one or more springs that are adapted to flex to provide for the relative movement.

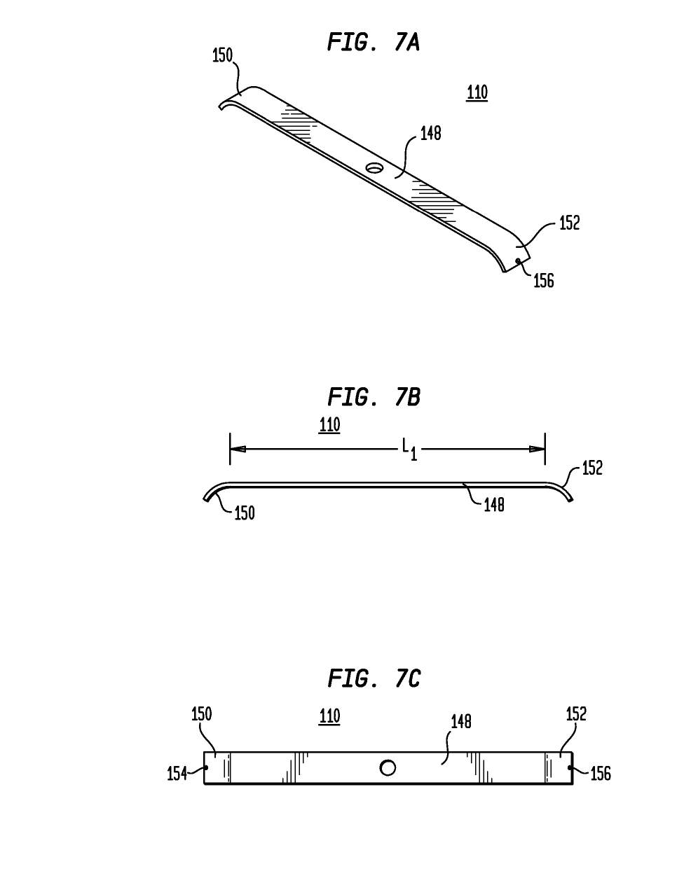

Referring to FIGS. 7A-7C, in one embodiment of the present invention, the vessel includes the mounting bracket 110 having a central section 148 that is preferably straight, a first end 150 that is curved, and a second end 152 that is curved. Referring to FIG. 7B, in one embodiment of the present invention, the central section has a length L1 of about 10-15 inches. Referring to FIGS. 7A and 7B, the first curved end 150 has an opening 154, and the second curved end 152 has an opening 156. The openings 154, 156 are preferably provided so that rigging may be secured to the mounting bracket 110.

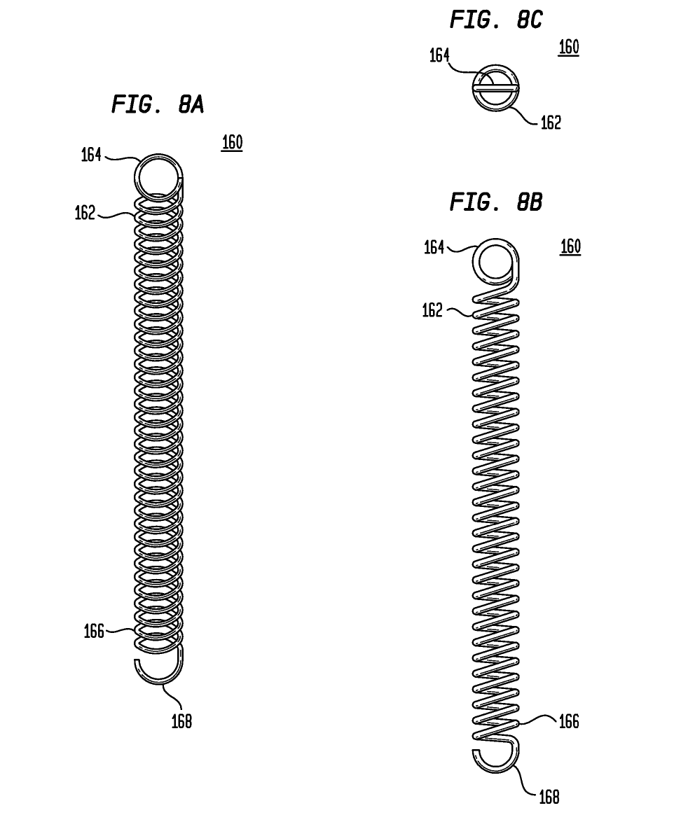

Referring to FIGS. 8A-8C, in one embodiment of the present invention, the vessel 100 (FIG. 1) includes one or more stabilizing springs 160 that couple the upper chamber section with rigging secured to the support frame. Each stabilizing spring 160 has an upper end 162 including an upper eyelet 164, and a lower end 166 including a lower eyelet 168. In one embodiment, the lower eyelet 168 is coupled with the outer wall of the upper chamber section and the upper eyelet is coupled with rigging that is, in turn, coupled with the support frame. Although the present invention is not limited by any particular theory of operation, it is believed that the stabilizing springs 160 enable the upper chamber section to move relative to support frame as the vessel expands and collapses. The stabilizing springs 160 essentially tether the upper support chamber to the support frame, thereby enabling the upper support member to move through a controlled range of motion in response to forces exerted upon the upper support chamber.

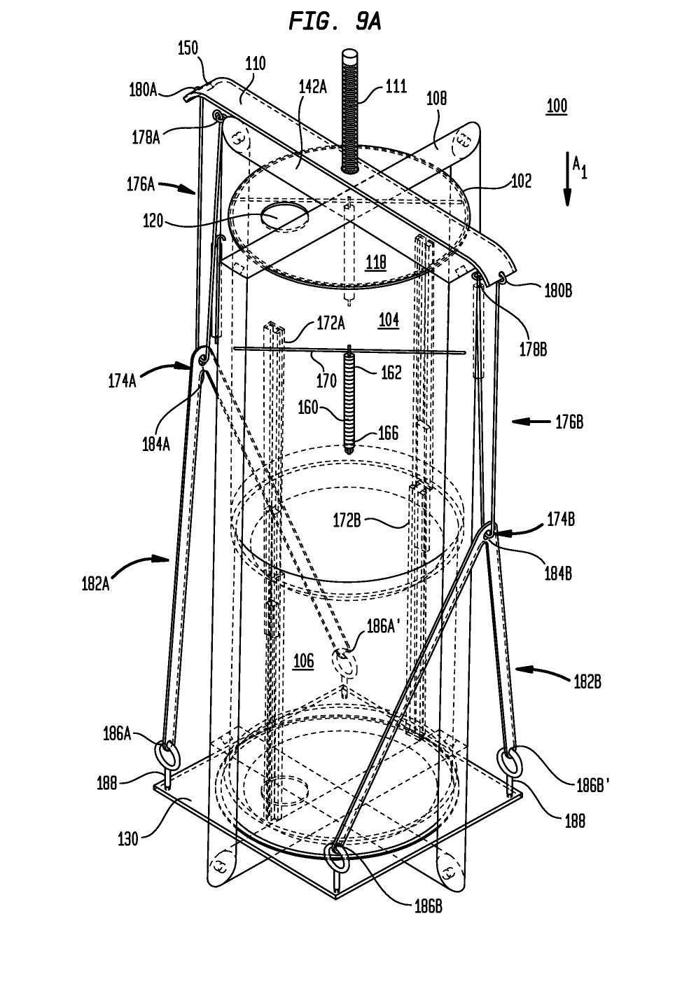

FIGS. 9A-9C show an energy producing vessel 100, in accordance with one embodiment of the present invention. The vessel 100 includes the expandable and collapsible chamber 102 having the upper chamber section 104 that slides telescopically over the lower chamber section 106. The upper chamber section 104 preferably has a larger area internal space than does the lower chamber section 106. The expandable and collapsible chamber 102 is disposed inside the support frame 108, and is adapted to move between a collapsed state for generating energy through gravitational forces and an expanded state for rising back to the top of tank through the forces of buoyancy. In certain preferred embodiments, the vessel produces energy only when sinking in the liquid, and no energy is generated as the vessel is rising. In one embodiment, however, the vessel is adapted to produce energy when both sinking (due to gravitational forces) and rising (due to buoyancy forces). The upper chamber section is preferably coupled with the support frame 108 using stabilizing springs 160. Each stabilizing spring 160 has a lower end 166 secured to the outer wall of the upper chamber section and an upper end 162 secured to support frame rigging 170. The support frame rigging 170 preferably extends between the vertically extending arms of the support frame 108. The upper ends 162 of the stabilizing springs are preferably connected to the support frame rigging. In one embodiment, the stabilizing springs are equally spaced from one another around the perimeter of the upper chamber section. In certain embodiments, the vessel includes four stabilizing springs that equally spaced from one another around the perimeter of the upper chamber section.

In one embodiment of the present invention, the expandable and collapsible chamber 102 preferably includes a pair of alignment brackets 172A, 172B that enable the upper chamber section 104 and the lower chamber section 106 to slide telescopically relative to one another. In other embodiments, however, the upper and lower chamber sections may be slidably coupled together using three, four, or more alignment brackets. Each alignment bracket has an upper end secured to the upper chamber section and a lower end secured to the lower chamber section. The sliding brackets 172A, 172B insure the alignment of the upper and lower chamber sections relative to one another as the upper and lower chamber sections move relative to one another. In certain preferred embodiments, the alignment brackets 172A, 172B may also control how far the upper and lower chamber sections collapse toward one another when moving into the collapsed state and how far the upper and lower chamber sections move away from one another when moving into the expanded state.

The energy producing vessel 100 also desirably includes the mounting bracket 110 that overlies the upper end of the support frame 108. The mounting bracket 110 is free to move relative to the upper end of the support frame, and is preferably generally aligned with one of the horizontally extending arms 142A of the support frame 108. The vessel 100 includes first outer rigging 174A and second outer rigging 174B that extend between the mounting bracket 110 and the bottom cover 130 of the lower chamber section 106. The first outer rigging 174A includes a first section 176A having a first end 178A secured to the support frame and a second end 180A secured to the first end 150 of the mounting bracket 110. The first outer rigging 174A includes a second section 182A having a first end 184A coupled with the first rigging section 176A and bifurcated second ends 186A, 186A′ secured to respective anchors 188 attached to the bottom cover 130. The first section 176A loops through an opening at the first end 184A of the second section 182A. The second outer rigging 174B includes a first rigging section 176B having a first end 178B secured to the support frame and a second end 180B secured to the second end 152 of the mounting bracket 110. The second outer rigging 174B includes a second section 182B having a first end 184B coupled with the first rigging section 176A and bifurcated second ends 186B, 186B′ secured to respective anchors 188 connected to the bottom cover 130. The first section 176B of the second outer rigging loops through an opening at the first end 184B of the second section 182B of the second outer rigging.

In one embodiment, when the expandable and collapsible chamber 102 moves in the direction indicated by the arrow A1, the line 111 provides resistance to downward movement of the mounting bracket 110. During this stage, due to the outer rigging 174A, 174B being coupled to the bottom cover 130, the bottom cover is pulled toward the top cover for collapsing the chamber 102. As noted above, the forces for collapsing the chamber 102 are provided at least in part through the outer rigging 182A, 182B. As the chamber 102 is collapsed, the alignment brackets 172A, 172B (FIG. 9A) guide the sliding movement of the lower chamber section 106 into the upper chamber section 104. The lower chamber section preferably slides telescopically into the upper chamber section so as to reduce the size of the air-tight space inside the chamber. As the volume of the air-tight space is reduced, air inside the chamber is discharged through the vent opening 120 (FIG. 9A).

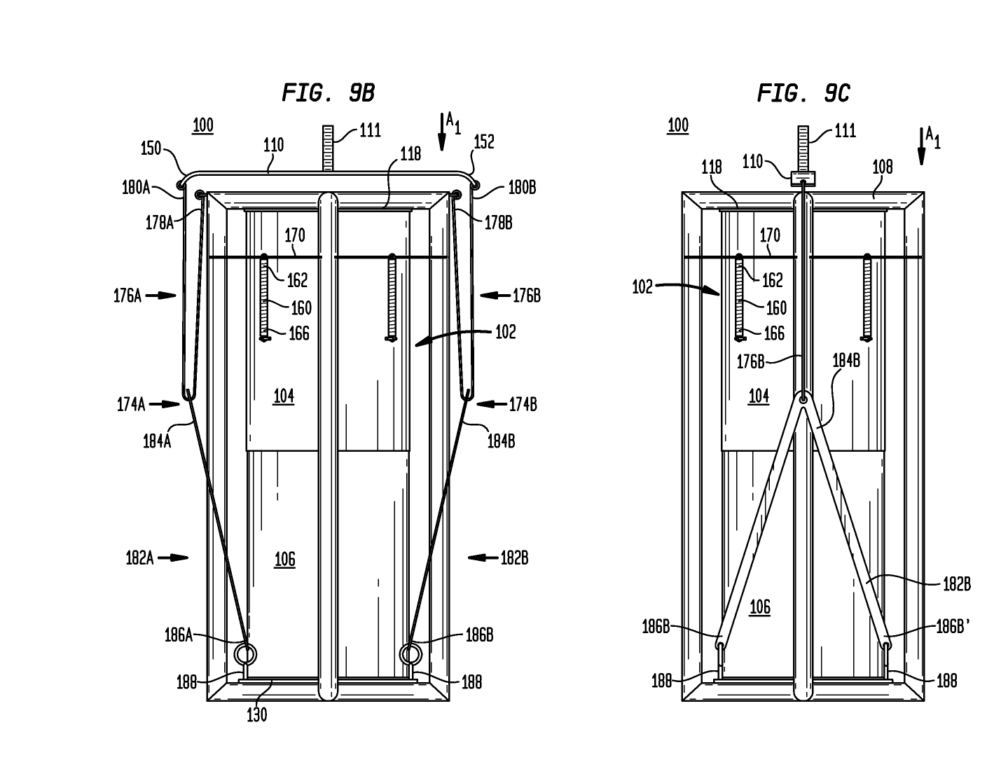

Operation of the above-described energy producing vessel will now be described in detail. As an initial matter, it is important to note that the vessels may be placed in one or more tanks filled with a liquid for producing energy. In certain preferred embodiments, the vessels may be placed in an open body of water such as the ocean, a lake, or a flowing body of water. Referring to FIGS. 10A-10C, in one embodiment of the present invention, an energy producing system includes a tank 190 having an internal space 192 filled with a liquid 194, such as water. The tank is elongated in a vertical direction and the liquid 194 has a water line 196 provided near the upper end of the tank 190. The vessel 102 is coupled with a one-way sprocket 198 which in turn is selectively coupled to a rotatable shaft 200. The sprocket 198 rotates with the shaft 200 in a first direction of rotation (e.g. counter-clockwise) for driving the shaft, but is de-coupled from the shaft 200 when rotating in a second direction. In other words, the vessel 102 is able to drive the shaft 200 in a first direction of rotation as the vessel moves toward the lower end of the tank 190, but does not exert forces on the shaft when moving toward the upper end of the tank.

In FIGS. 10A-10C, as the vessel 102 moves toward the bottom of the tank, the mounting bracket 110 and the outer rigging 174A, 174B collapse the chamber 102 by pulling the upper chamber section over the lower chamber section. In other words, the outer rigging 174A, 174B pulls the upper chamber section and the support frame toward the bottom cover 130 of the lower chamber section. As noted above, the combined weight of the upper chamber section and the support frame may be up to 10 times less (or more) that the weight of the lower chamber section. Thus, as the parts of the vessel move relative to one another, the laws of momentum dictate that it will be easier to move the upper chamber section as opposed to the lower chamber section. As the chamber collapses, the air inside the chamber is vented to the atmosphere through vent line 136. The vent line 136 may be flexible in response to movement of the vessel.

As shown in FIGS. 10A-10C, in one preferred embodiment, after the vessel has been collapsed, the vessel is at least partially above the water-line 196. Because the chamber is collapsed, and due to the reduced volume of air inside the chamber, the vessel will begin to sink in the liquid 194 due to the forces of gravity. As the vessel sinks toward the bottom of the tank 190, the downward force generated by the vessel will pull the anchor line 111 in a downward direction which will rotate the sprocket 198, which, in turn, will drive the shaft 200 to produce energy.

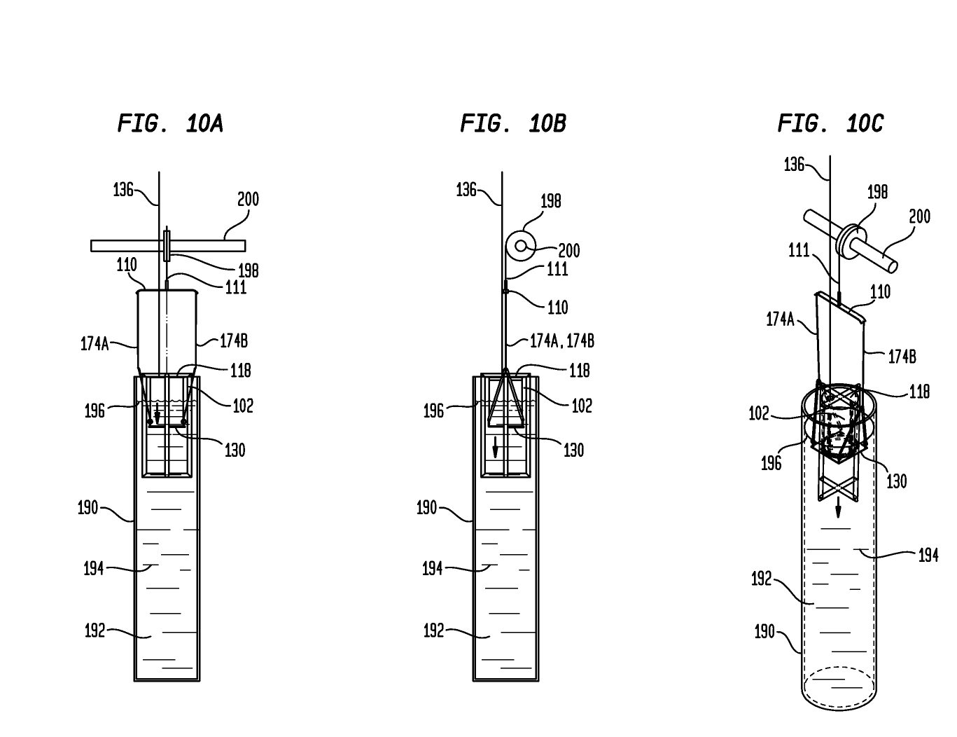

Referring to FIGS. 11A-11C, as the vessel 102 in a collapsed state drops toward the bottom of the tank 190, the anchor line 111 rotates the one-way sprocket 198 which rotates the shaft 200 to produce energy. As the vessel moves toward the bottom of the tank, the vent line 136 remains connected to the chamber and moves downwardly with the chamber. The vessel continues to rotate the shaft 200 and produce energy so long as it continues to move in a downward direction toward the lower end of the tank 190.

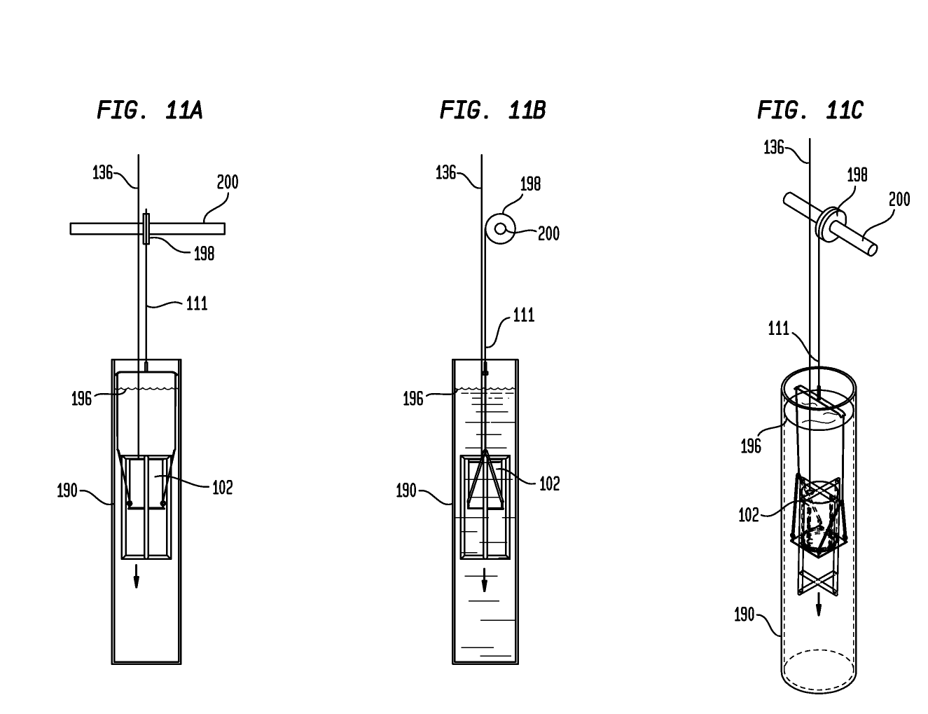

Referring to FIGS. 11A-11C and 12A-12C, the vessel 102 continues to move toward the bottom of the tank 190 until the bottom of the support frame 108 contacts the bottom floor of the tank 190. At that stage, the support frame of the vessel is arrested from further downward movement. This is perhaps best shown in FIG. 12C, which shows the bottom of the support frame 108 engaging the floor of the tank 190. Once the vessel is stopped from further downward movement, the anchor line 111 no longer rotates the sprocket 198, and the sprocket no longer rotates the shaft 200 to produce energy.

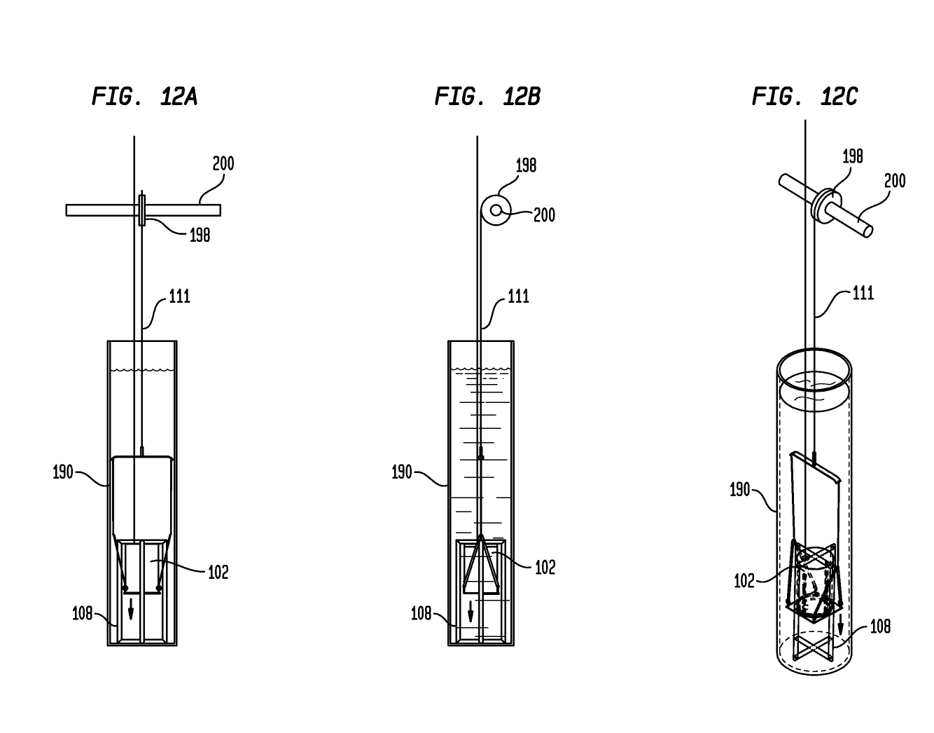

Referring to FIGS. 13A-13C, after the support frame 108 engages the floor of the tank 190, the bottom cover 130 of the lower chamber section 106 continues to move toward the bottom floor of the tank 190. Although the lower chamber section is disposed inside the support frame 108, the lower chamber section remains free to slide telescopically relative to the upper chamber section 104. The continued downward movement of the lower chamber section may be due to a number of factors including gravitational forces and momentum forces. As the lower chamber section moves downwardly relative to the upper chamber section, the interior volume of the air-tight chamber expands. In response to the expansion of the air-tight chamber, air is drawn into the internal chamber through vent line 136. As air enters the air-tight chamber, the buoyancy of the vessel increases. As noted above, the lighter weight of the upper chamber section relative to the lower chamber section makes it easier to move the upper chamber section during the expansion stage. As the upper chamber section begins to move, that section of the chamber rapidly becomes buoyant which further enhances the separation of the upper and lower chamber sections away from one another, which further increase the buoyancy of the vessel because the air-tight vessel is displacing more liquid.

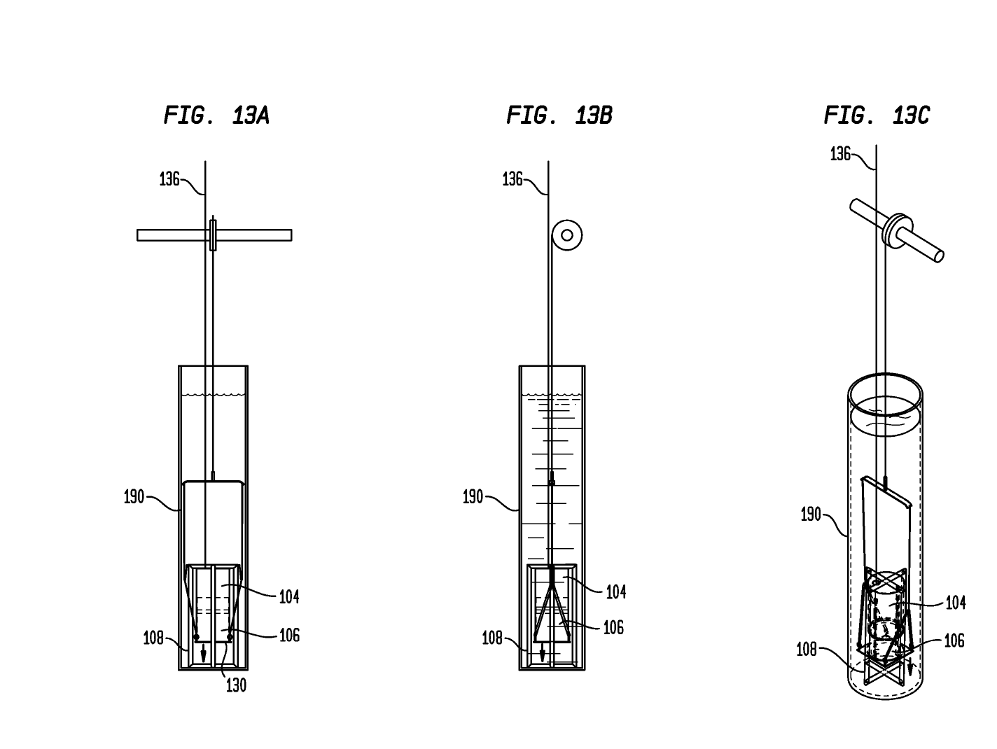

FIGS. 14A-14C show the vessel 102 at the bottom of the tank 190, and after the chamber has fully expanded. At this stage, the air-tight chamber is completely filled with air drawn through vent line 136 so that the internal volume of the chamber is at a maximum. As the vessel 102 becomes filled with air, the vessel becomes buoyant so that it will begin to float toward the upper end of the tank 190. Although the present invention is not limited by any particular theory of operation, it is believed that providing an upper chamber section having both a larger internal volume and a lower weight than the lower chamber section will improve the buoyancy forces generated by the vessel. In the stage shown in FIGS. 14A-14C, the upper chamber section and the support frame begin to float upwardly because the upper chamber section displaces more liquid than it weighs. As a result, the upper chamber section and the support frame will float away from the relatively heavier lower chamber section to a predetermined distance that is controlled by the sliding brackets that couple the upper and lower chamber sections together. The force of buoyancy acts upon the lighter-weight upper chamber section with the same effect as is observed with air pockets or inflated balloons, thereby generating an upward motion. As the vessel expands, it ultimately achieves a volume that is more than twice the size of the vessel when the vessel is collapsed. In the expanded state, the vessel is displacing more liquid than it weighs.

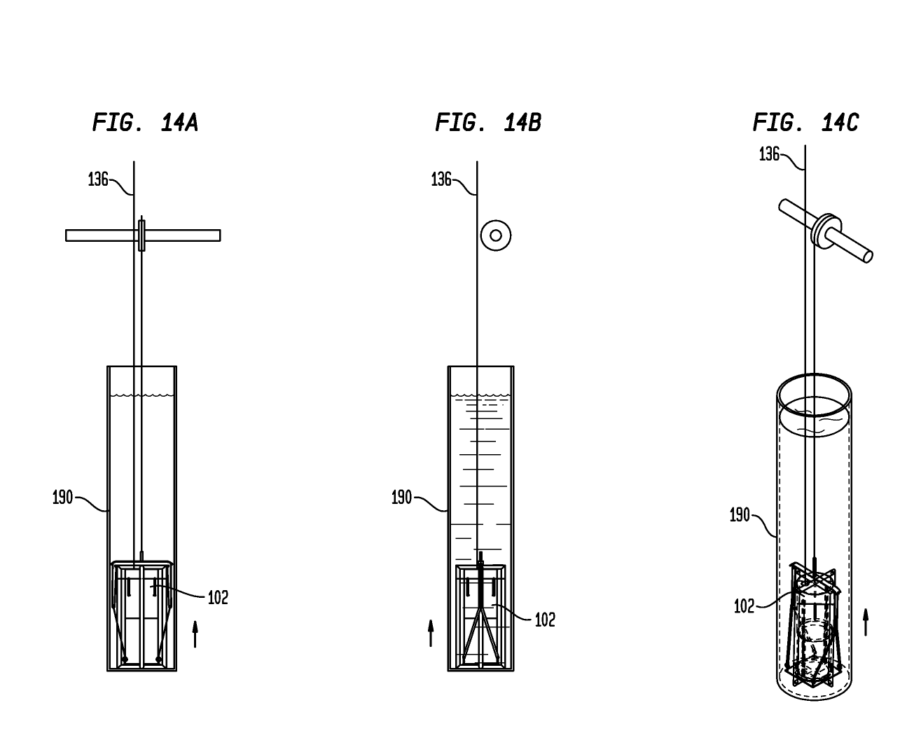

FIGS. 15A-15C show the fully expanded vessel 102 moving upwardly toward the upper end of the tank 190. The vessel 102 is desirably completely filled with air, which makes the vessel 102 more buoyant than the surrounding liquid. As a result, the now buoyant vessel 102 rises inside the tank toward the water line 196. As the vessel rises, the vent line 136 moves with the vessel. In addition, the sprocket 198 free-wheels relative to the shaft 200 so that the sprocket does not exert any forces on the shaft as the vessel is moving upwardly. Moreover, as the vessel moves upwardly, the anchor line 111 is wound around the sprocket 198.

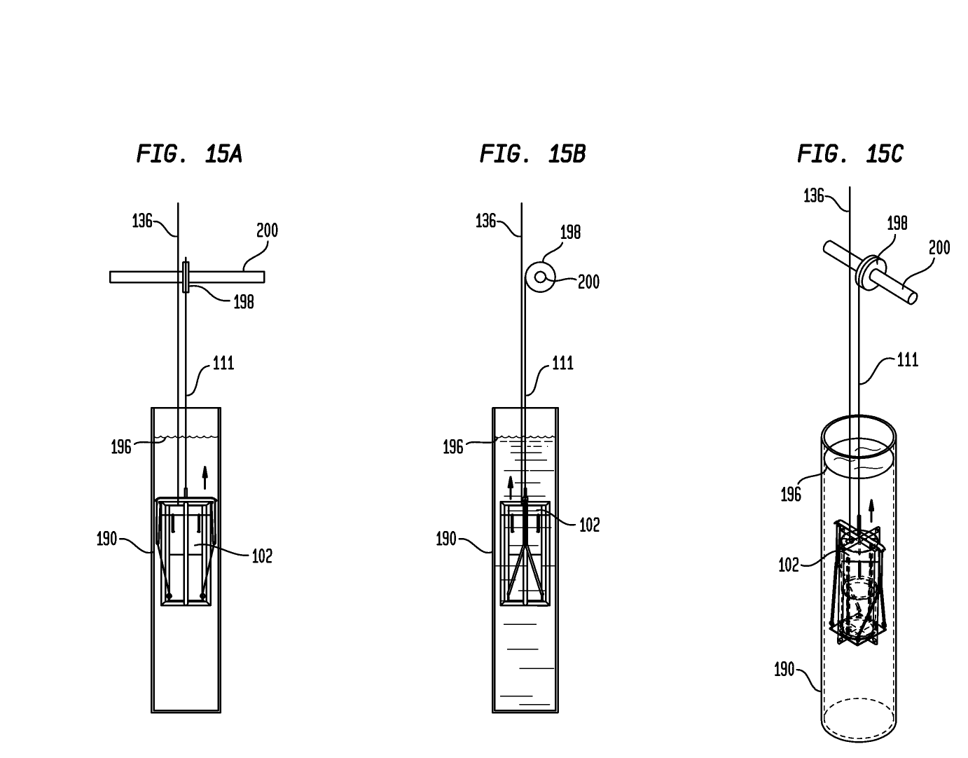

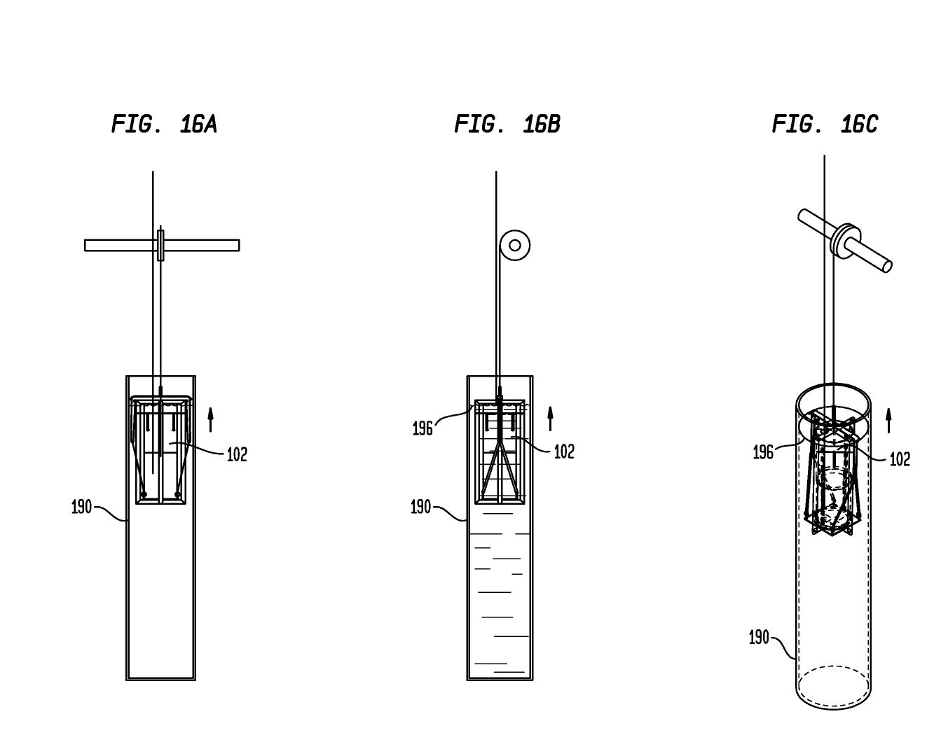

FIGS. 16A-16C show the buoyant vessel 102 as it reaches the water line 196. As noted above, the sprocket 198 is adapted to free wheel relative to the rotatable shaft 200 as the vessel moves toward the upper end of the tank 190. Referring to FIGS. 17A-17C, due to the highly buoyant nature of the fully-expanded vessel 102, the upper end of the vessel 102 including a portion of the support frame 108 and a portion of the upper chamber section 104 breaches the waterline 196. Thus, at least a portion of the vessel is exposed above the waterline 196. FIG. 17B shows the vessel 102 at its highest point above the waterline.

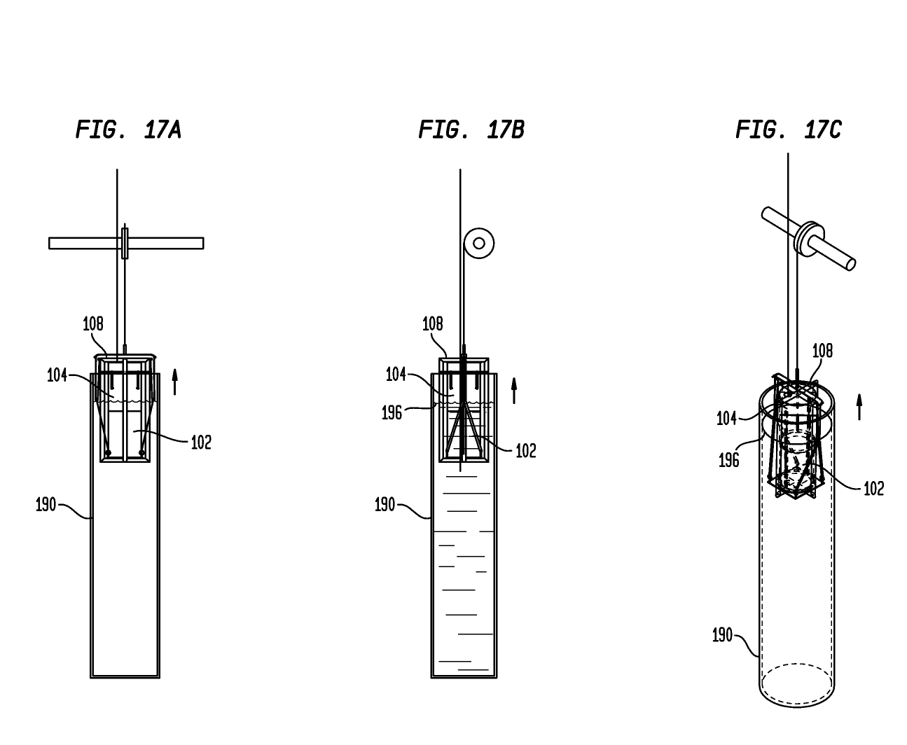

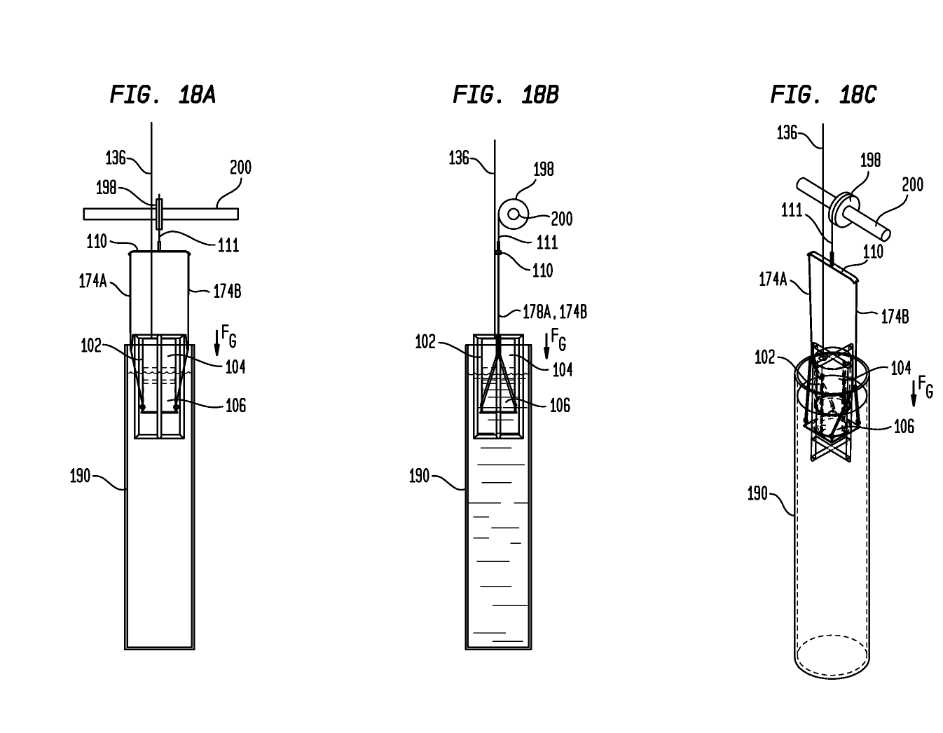

Referring to FIGS. 18A-18C, the gravitational forces Fg become greater than the buoyancy forces so that the vessel 102 once again begins moving toward the bottom of the tank 190. As the vessel 102 moves downwardly, the anchor line 111 and the mounting bracket 110 resist downward movement of the vessel 102. As a result, the sprocket 198 re-engages the shaft 200 and begins to drive rotation of the shaft. In addition, the outer rigging 174A, 174B collapses the vessel 102 by pulling the upper chamber section 104 and the support frame over the lower chamber section 106. As the upper chamber section is pulled over the lower chamber section, air inside the air-tight chamber is expelled through the vent line 136. In one embodiment, each vent line has a distal end that is positioned outside the liquid and that is adapted to pass gasses such as air therethrough. FIGS. 18A-18C show the vessel 102 after it has been partially collapsed. FIGS. 19A-19C show the vessel 102 after it has been fully collapsed. Due to gravitational forces Fg, the vessel drops through the liquid 194 toward the bottom of the tank 190. As the vessel drops, the anchor line 111 moves in a downward direction for rotating the sprocket 110 which, in turn, rotates the shaft 200 for generating energy.

In certain preferred embodiments, the above-described proves is repeated to continuously rotate a shaft for generating energy. As the vessel moves downwardly in a tank due to gravitational forces, the vessel drives rotation of a power shaft to produce energy. As the vessel moves upwardly in a tank due to buoyant forces, the vessel does not drive rotation of the drive shaft. However, once the vessel has been lifted to its apex in the tank due to buoyancy, the vessel is once again coupled to the shaft for driving the shaft and generating energy.

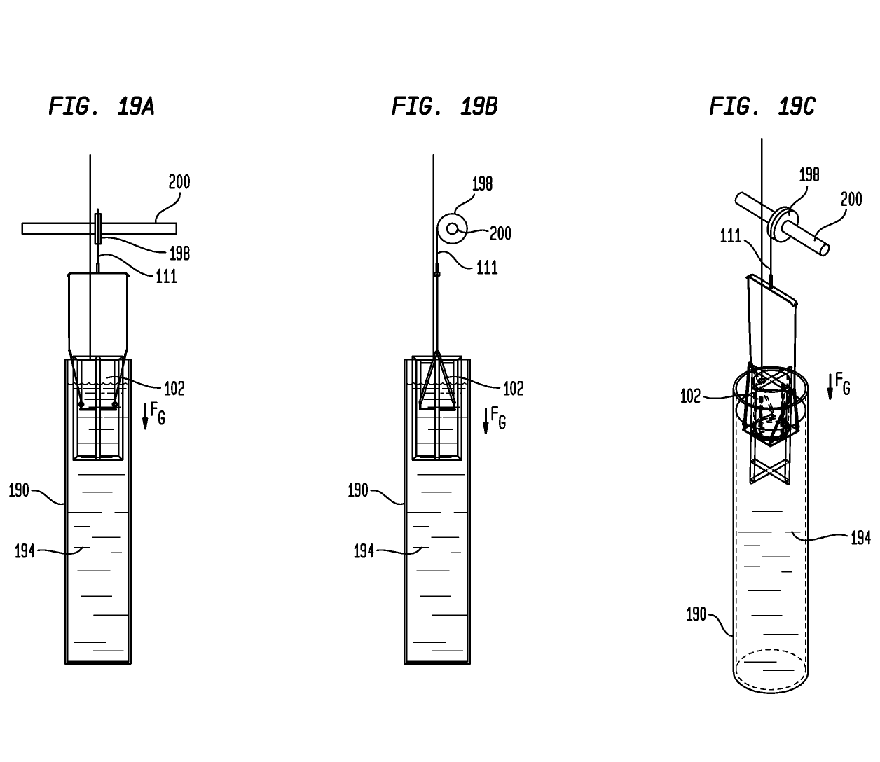

FIG. 20 shows a system for producing energy, in accordance with one preferred embodiment of the present invention. The system includes four separate tanks 190A-190D, with each tank being filled with a liquid. The system includes a vessel 102A-102D disposed inside each tank 190. The first vessel 102A and the first tank 190A comprise a first energy producing station 210A. The second vessel 102B and the second tank 190B comprise a second energy producing station 210B. The third vessel 102C and the third tank 190C comprise a third energy producing station 210C. The fourth vessel 102D and the fourth tank 190D comprise a fourth energy producing station 210D. Each of the vessels 102A-102D are selectively coupled to rotatable shaft through respective anchor lines 111A-111D and sprockets 198A-198D. As described above, the sprockets 198A-198D are adapted to be drivingly coupled with the shaft 200 when rotating in a first direction and de-coupled from the shaft 200 when rotating in a second direction.

In FIG. 20, the first vessel 102A is fully expanded so that it is buoyant. The first vessel 102A is moving upwardly toward the top of the tank 190A due to the forces of buoyancy Fb. At the same time, the second vessel 102B has reached the bottom of the second tank 190B and has fully expanded to reach a state whereby it is more buoyant than the surrounding liquid. As a result, the second vessel 102B is being urged upwardly by the forces of buoyancy Fb. Simultaneously, the third vessel 102C is collapsed and due to gravitational forces Fg is moving toward the bottom of the third tank 190C. As the third vessel 102C drops toward the bottom of the tank 190C, the third anchor line 111C rotates the third sprocket 198C which, in turn, rotates the rotatable shaft 200 for producing energy. At the same time, the fourth vessel 102D is also collapsed and dropping in the fourth tank 190D due to gravitational forces Fg. As the fourth vessel 102D drops in the tank, the fourth anchor line 111D rotates the fourth sprocket 198D, which, in turn, drives rotation of the shaft 200. The four vessels 102A-102D continue to move up and down in the respective tanks 190A-190D as the vessel are collapsed and expanded. In the collapsed state, the vessels drop due to gravitational forces. In the expanded state, the vessels rise due to buoyant forces. When the vessels drop, the vessels are coupled with the shaft 200 for rotating the shaft and producing energy. When the vessels are rising, the vessels are temporarily de-coupled from the shaft, however, the shaft 200 continues to rotate because it is being driven by at least one of the other vessels that is dropping in at least one of the other tanks. The above-described process may be continued repeatedly for continuously driving rotation of the shaft 200.

The embodiment of FIG. 20 shows an energy system having four units 210A-210D, each unit having a single collapsible and expandable vessel 102. Other embodiments of the present invention, however, may have more or less units. For example, certain embodiments of the present invention may have 10, 20, 30 or more units 210, with each unit having at least one vessel. Still other preferred embodiments of the present invention may have only one or two energy producing units, each unit having at least one expandable and collapsible vessel

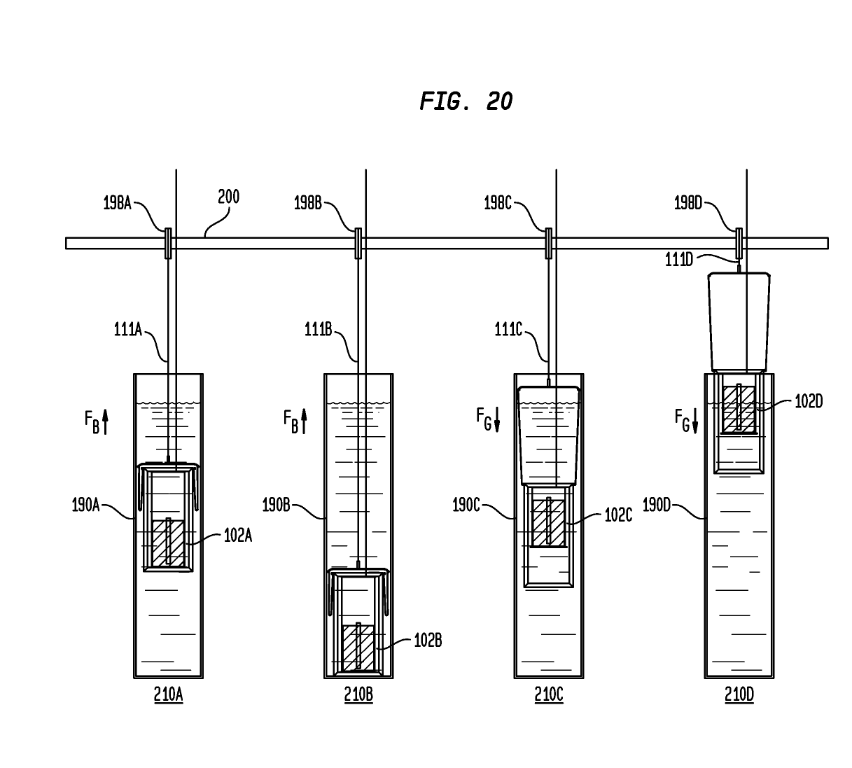

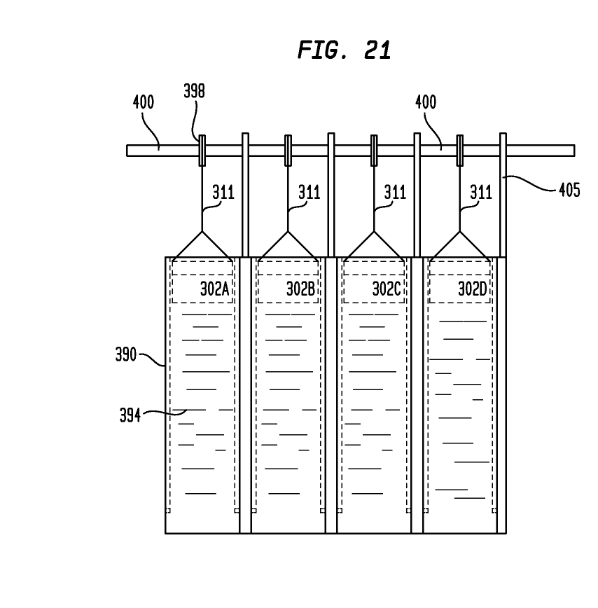

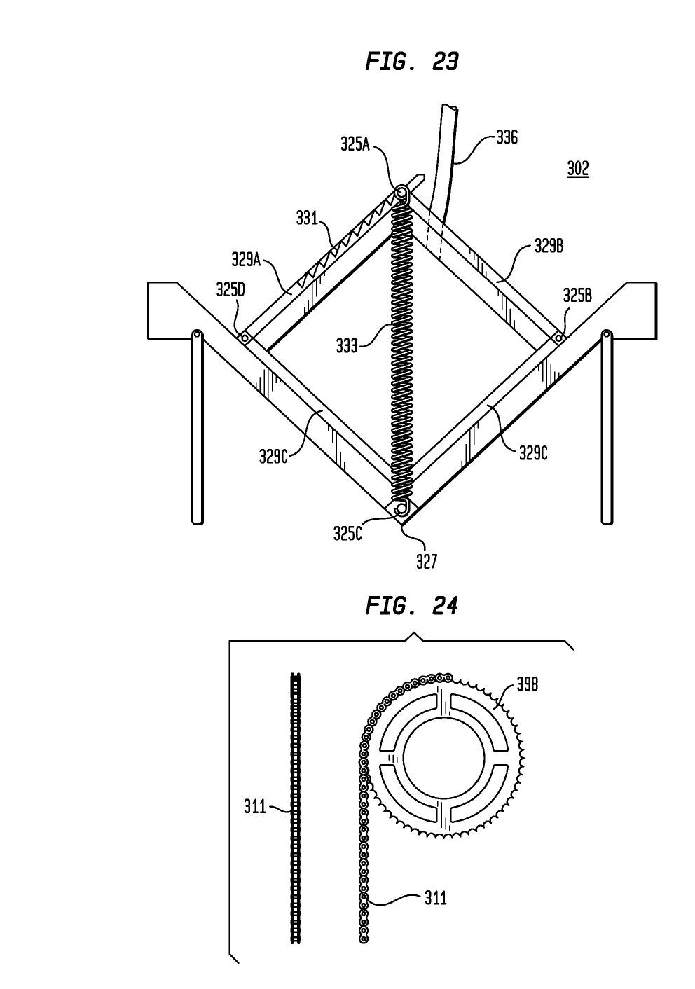

Referring to FIGS. 21 and 22, in accordance with another preferred embodiment of the present invention, a system for producing energy includes a tank 390 that is filled with a liquid such as water. The system includes a rotatable shaft 400 that is supported by a harness 405 or other device that allows the shaft 400 to turn freely. Referring to FIGS. 22 and 24, the system includes sprockets 398 or other gear mechanisms that are attached to the shaft 400. The sprockets 398 are adapted to rotate the shaft in one direction and freewheel relative to the shaft when rotating in the opposite direction. Chains 311 or other similar devices are looped over or otherwise attached to the sprockets 398 so that movement of the chains causes the shaft 400 to turn when weighted vessels attached to the chains or other similar devices fall through the liquid.

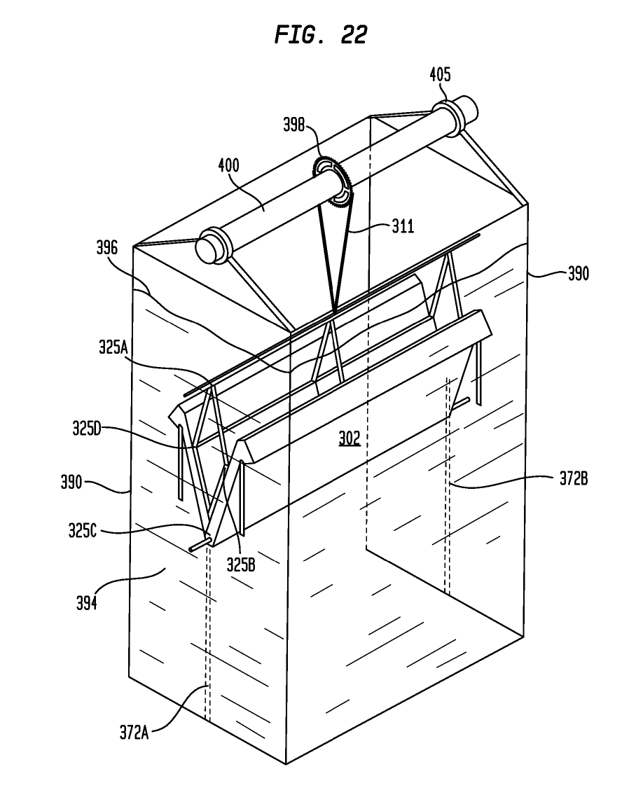

Referring to FIGS. 21 and 22, vessels 302A-302D are coupled with the sprockets 398 through the chains 311. Referring to FIGS. 22 and 23, the vessels 302 are designed with hinges 325A-325D or flexible couplings at every corner so that the vessels may be collapsed along the hinges. In one embodiment, the vessel 302 is collapsed into the shape shown in FIG. 22 (e.g. a knifelike shape) when at the top of the tank 390 which enables the vessels to fall through the liquid 394 due to gravitational forces. As the vessel 302 drops in the tank 390, the chain 311 rotates the sprocket 398 which, in turn, rotates the shaft 400 for producing energy. The amount of force exerted on the shaft 400 will desirably equal the actual weight of the vessel 302 minus any reduction caused by the mass/density of the vessel.

Referring to FIGS. 21 and 22, the vessels 302 are attached to guide rails 372A, 372B that control the path that the vessel as the vessels move between the upper and lower ends of the tank 390.

Referring to FIGS. 22 and 23, in one embodiment, the vessel 302 is designed so that when the lowest end 327 of the vessel 302 reaches the lower end of the guide rails 372A, 372B, the panels 329A-329D of the vessel 302 begin to open along the hinges 325A-325D, which causes the vessel to expand and change shape so that the vessel is capable of holding air or another gaseous substance. One or more springs 333 assist in opening the vessel to the expanded state. The result is that the vessels open into an expanded shape (e.g. similar to a ship's hull), as shown in FIG. 23.

In one embodiment, the vessels are covered with a waterproof membrane or coating or otherwise rendered waterproof which allows the air or other gaseous substance to be trapped inside. In one embodiment, the vessel 302 includes a ratcheting mechanism 331 so that when the vessel reaches the bottom of the tank, the vessel moves into the expanded state and the hinges become locked with the vessel in the expanded state.

Referring to FIG. 23, in one embodiment, ambient air or another gaseous material may be introduced into the vessel using a vent line 336, such as a flexible hose. Once the vessel has been expanded into the shape shown in FIG. 23, the vessel in filled with air and becomes buoyant. The vessel will then begin to rise to the surface 396 of the water 394 using the principle of buoyancy as the only force. As the tops of the vessels 302 breach the surface 396 of the liquid 394, the mechanical ratcheting locks 331 are released as the vessels attempt to settle. At this point, the vessels collapse into a knifelike shape (FIG. 22) along the hinges 325A-325D assisted by a spring attached to the top and bottom ends of the vessel.

After the vessel has reached the top of the tank and it is collapsed, air inside the vessel may be exhausted through the venting line 336. Since the sprockets 398 only turn the shaft 400 in one direction, the rise of the vessels 302 do not impede the turning of the shaft 400.

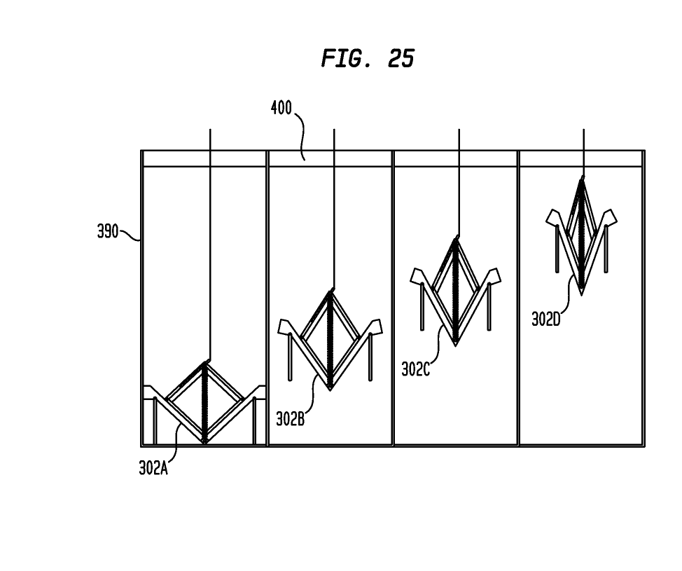

Referring to FIG. 25, in one embodiment, multiple vessels 302A-302D are positioned on the shaft 400, with one or more of the vessels falling and one or more of the vessels rising at all times so that the shaft is being continuously driven by at least one of the vessels. The shaft 400 may be connected to a gear mechanism or gearbox. In one embodiment, the rate of descent of the vessels may be controlled by multiplying the shaft rotation using the gear mechanism or gearbox. The output end of the shaft 400 is desirably connected to a turbine or generator or other device such as a hydraulic pump or other type of pump which causes a generator to turn, thereby producing electricity. The shaft may also be connected to any other device that requires torque. The torque produced by the invention can be adjusted by using gears attached to the shaft.

In one embodiment, an energy system includes a plurality of weighted vessels that are adapted to fall and rise in water or other liquid. The vessels are attached to chains or other similar devices, which, in turn, are attached to one way sprockets or other gear mechanisms, which, in turn, are attached to a rotatable drive shaft.

In one embodiment of the present invention, a weighted vessel in a collapsed state will change its shape at the end of its descent and becomes buoyant, which causes it to return to the surface without the application of outside fuel or energy. The vessel may include one or more springs that assist in expanding the vessel so that the vessel becomes buoyant. In one embodiment, as the buoyant vessel rises, it desirably does not exert a force upon the continuously rotating shaft. The vessel desirably exerts a force on the shaft only when it is falling due to gravitational forces. When the vessel has returned to the top of the tank, the vessel once again collapses thereby making it capable of descending through the liquid without the application of outside fuel or energy. As the vessel changes from a collapsed state into an open state, the vessel draws air therein, thereby transforming the vessel into a buoyant structure that is able to rise through a liquid.

While the foregoing is directed to embodiments of the present invention, other and further embodiments of the invention may be devised without departing from the basic scope thereof.

What is claimed is:

1. A system for producing energy comprising:
a tank holding a liquid;
an air-tight, expandable vessel disposed within said liquid and adapted to move reciprocally between upper and lower ends of said tank;
a conduit attached to said vessel for passing gases into and out of said vessel;
a linkage for selectively coupling said vessel with a rotatable shaft;
said vessel being moveable between a collapsed state in which said vessel sinks in said liquid due to gravitational forces and an expanded state in which said vessel rises in said liquid due to buoyancy forces.

2. The system as claimed in claim 1, wherein said linkage drives rotation of said shaft when said vessel sinks and said linkage decouples from said shaft when said vessel rises.

3. The system as claimed in claim 2, wherein said linkage includes a sprocket disposed on said shaft for driving rotation of said shaft when rotating in a first direction and freewheeling relative to said shaft when rotating in a second direction.

4. The system as claimed in claim 1, wherein said linkage comprises a one-way clutch.

5. The system as claimed in claim 1, wherein said conduit comprises a flexible hose.

6. The system as claimed in claim 1, wherein said expandable vessel comprises an expandable chamber including an upper chamber section and a lower chamber section that are coupled together.

7. The system as claimed in claim 6, wherein said upper chamber section has an internal volume that is larger than an internal volume of said lower chamber section.

8. The system as claimed in claim 6, wherein said upper chamber section and said lower chamber section have a weight ratio of at least 1:10.

9. The system as claimed in claim 6, further comprising a flexible member extending between said upper and lower chamber sections for forming an air-tight seal between said upper and lower chamber sections.

10. The system as claimed in claim 6, wherein said upper and lower chamber sections are coupled together by sliding brackets that enable said upper and lower chamber sections to slide telescopically relative to one another.

11. The system as claimed in claim 1, further comprising a plurality of air-tight, expandable vessels coupled with said rotatable shaft.

12. The system as claimed in claim 11, wherein each said expandable vessel moves independently of one another.

13. The system claim claimed in claim 6, further comprising a support frame surrounding said upper and lower chamber sections.

14. The system as claimed in claim 13, wherein said upper chamber section is connected to said support frame for limiting movement of said upper chamber section relative to said support frame and said lower chamber section is freely moveable relative to said support frame.

15. The system as claimed in claim 13, further comprising rigging coupled with said linkage, said support frame and said lower chamber member for selectively moving said upper chamber section over said lower chamber section.

16. A system for producing energy comprising:
at least one tank holding a liquid;
a plurality of air-tight, expandable vessels disposed within said liquid, each said vessel being adapted to move reciprocally between upper and lower ends of said at least one tank;
a conduit attached to each said vessel for passing gasses into and out of said vessels;
linkages for coupling said vessels with a rotatable shaft;
said vessels being moveable between a collapsed state during which said vessels sink in said liquid due to gravitational forces for rotating said shaft, and an expanded state during which said vessels rise in said liquid due to buoyancy forces.

17. The system as claimed in claim 16, wherein each said vessel comprises an air-tight, expandable chamber having an upper chamber section and a lower chamber section that are telescopically coupled together.

18. The system as claimed in claim 16, wherein each said linkage comprises a one way clutch that drives said shaft when said vessels are sinking and that freewheels relative to said shaft when said vessels are rising.

19. The system as claimed in claim 16, wherein said vessels are disposed at different elevations relative to one another.

20. The system as claimed in claim 16, wherein said vessels are spaced so during operation a first one of said vessels is in a collapsed state for sinking due to gravitational forces and a second one of said vessels is in an expanded state for rising due to buoyancy forces.

21. A method of producing energy comprising:
submerging a plurality of air-tight vessels in a liquid;
collapsing one or more of said vessels so as to make said collapsed vessels less buoyant than said liquid;
expanding one or more of said vessels so as to make said expanded vessels more buoyant than said liquid;
coupling said collapsed vessels to a rotatable shaft for rotating said shaft as said collapsed vessels sink in said liquid;
decoupling said expanded vessels from said rotatable shaft as said expanded vessels rise in said liquid.

22. The method as claimed in claim 21, wherein each said vessel comprises an upper chamber section and a lower chamber section that are telescopically coupled together, each said upper chamber section having a larger internal volume and a lower weight than said lower chamber section associated therewith.

23. The method as claimed in claim 21, further comprising connecting a conduit to each said vessel for drawing air into said vessels as said vessels are expanded and exhausting air from said vessels as said vessels are collapsed.

24. The method as claimed in claim 21, further comprising positioning each said vessel at a different elevation in said liquid.

25. The method as claimed in claim 21, wherein said collapsed vessels drive rotational of said shaft due to gravitational forces and said expanded vessels rise to the top of said liquid due to buoyancy forces.
